(19) United States
(12) Patent Application Publication
(10) Pub. No.: US 2020/0408395 A1
(43) Pub. Date: Dec. 31, 2020

(54) Power supply system for a lamp support

(71) Applicant: Light Manufacture GmbH, Handewitt (DE)

(72) Inventor: Steve Becker, Handewitt (DE)

(73) Assignee: Light Manufacture GmbH, Handewitt (DE)

(21) Appl. No.: 16/721,039

(22) Filed: Dec. 19, 2019

(30) Foreign Application Priority Data
Jun. 25, 2019 (EP) 19182220.4

(51) Int. Cl. F21V 23/06; F21V 23/02; H01R 33/05; H01R 13/62

(52) U.S. Cl. CPC F21V 23/06; F21V 23/023; F21Y 2115/10; H01R 13/6205; H01R 33/05

(57) ABSTRACT

A power supply system for producing a releasable and electrically conductive connection between a lamp support having at least one lamp and one line-like power supply element, has mutually congruent, current-conducting contact profiles. At least one contact profile has a permanent magnet and at least one contact profile has a permanent magnet and/or a ferromagnetic material. Sides of the contact profiles facing each other have a different polarity and/or attract each other. The power supply system comprises, in addition to the line-like and releasable power supply element that can be arranged on the contact profile, at least one rechargeable power supply, which also has a contact profile having a permanent magnet or a ferromagnetic material, which corresponds with the contact profile in a congruent, magnetically retentive manner.

### TECHNICAL FIELD

The present disclosure relates to a power supply system for a lamp support.

### BACKGROUND

Power supply systems for producing a releasable and electrically conductive connection between a lamp support having at least one lamp and one line-like power supply element are known in the prior art.

The patent application DE 101 61 709 A1 describes a current-carrying connection in the form of a (current-carrying) cable which, for example, serves to supply an LED and which is formed from a plug and a socket. Both the plug and the socket have mutually congruent contact surfaces and at least one connecting means has a permanent magnet and another connection has a ferromagnetic material, which have a different polarity and attract each other. It is provided that the magnetically connected connecting elements are current-conducting. Both connecting means can also comprise magnets which are differently poled to form a magnetic connection.

The patent application DE 10 2006 002 433 A1 describes a lighting system in which a current-conducting connection formed from magnetic contacts is provided, wherein a supply is provided at low voltage.

Furthermore, the patent application DE 101 61 709 A1 also describes a magnetic power connection, wherein the described locking device is limited primarily to a plug/socket connection.

### SUMMARY

The present disclosure provides a power supply system for a lamp support. The power supply system creates a linkage of such connections to a battery or rechargeable battery which likewise has a magnetic connection for coupling to a lamp. The two connections, battery or rechargeable battery (housing)/lamp, and cable/lamp alike form magnetic connections, which are identical and thus mutually replaceable without further adapters. The power supply system primarily serves the purpose of being able to use such a lamp support universally and easily, while allowing easy replacement of the power-supplying components depending on the intended use.

A power supply system of the aforementioned type is characterized in that the power supply system, in addition to the line-like and releasable power supply element that can be arranged on the contact profile, comprises at least one rechargeable power supply (rechargeable battery), which also has a contact profile having a permanent magnet or a ferromagnetic material, which corresponds with the contact profile in a congruent, magnetically retentive manner.

In a preferred embodiment, a lamp support having an LED is provided with a magnet which can conduct current. This makes it possible to provide the LED directly with a rechargeable battery, which also has a magnet and thus produces a current-conducting contact. It would also be possible, for example, to supply the LED with current using a rechargeable battery pack or alternatively to charge the rechargeable battery pack with the magnetic contact via a charging shell (also with magnetic contact).

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a lamp support and a rechargeable battery housing arranged thereon.

FIG. 1a is an enlarged view of the rechargeable battery housing in cross sectional view.

FIG. 2 a lamp support and a line-like power supply element arranged thereon.

### DETAILED DESCRIPTION

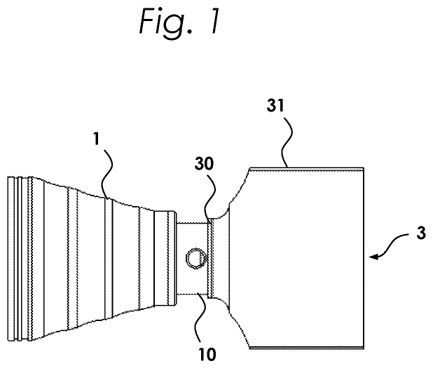

As shown in FIG. 1, a power supply system comprises a conical lamp support 1 having an LED lamp and a rechargeable power supply 3, which has a contact profile 30 having a permanent magnet or a ferromagnetic material, which corresponds with the contact profile 10 of the lamp support 1 in a congruent, magnetically retentive manner.

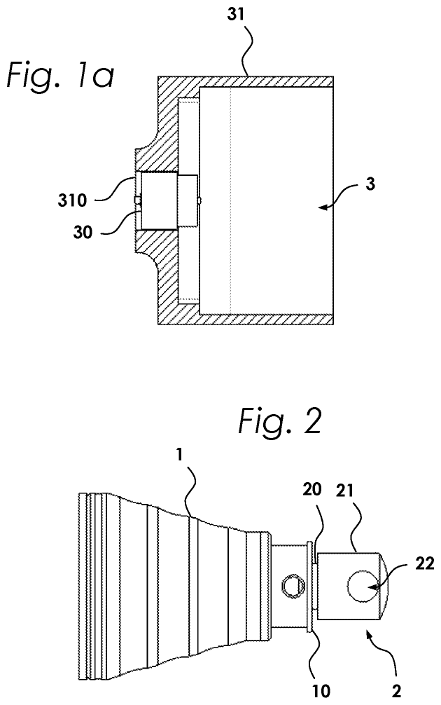

As shown in FIG. 2, the power supply elements 2, 3 are formed to be interchangeable and, for this purpose, each have congruent and particularly advantageously identically formed contact profiles 20, 30 for the contact profile 10. The line-like power supply element 2 advantageously comprises a connection profile 21 which supports the contact profile 20. In the embodiment of the invention illustrated in FIG. 2, the line 22 is arranged on the connection profile 21 in such a way that it is oriented orthogonally to the longitudinal direction of the lamp support 1.

The power supply 3 in FIG. 1a preferably comprises a housing 31, in a wall of which the contact profile 30 is embedded, wherein the housing 31 has at least one opening 310 into which the contact profile 30 is embedded, preferably in a form-fitting manner.

It is particularly advantageous to form the contact profile 30 in an approximately flat plane with the surface of the wall, so as to obtain a particularly compact and user-friendly design of the power supply element 30.

A further advantageous embodiment provides that the magnetic contact profiles 10, 30 are formed such that the housing 31 of the power supply 3 acts as a support of the lamp support 1. For this purpose, the at least one magnet of the contact profiles 10, 30 must have a sufficient adhesive force in order to hold the lamp support 1. The adhesive force should correspond to at least the weight of the lamp support.

In order to increase the adhesive force between the lamp support 10 and the contact profiles 20, 30, the contact profile connections 10, 20 and 10, 30 can additionally be designed as plugs/sockets.

In a further conceivable embodiment, the housing 31 comprises releasable connecting means, by means of which the housing 31 can be arranged on objects.

Such connecting means can be clamps, screw connections, magnetic connectors, hook and loop connectors or other positive and/or non-positive connection means. The housing 31 could thus, for example, be attached to a pair of glasses or a tool.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### LIST OF REFERENCE NUMBERS

1 lamp support
2 line-like power supply element
3 rechargeable battery
20 contact profile to 2
21 connection profile to 2
22 line to 2
30 contact profile to 3
31 housing for 3
310 opening at 31

What is claimed is:

1. A power supply system, comprising
a lamp support with a lamp,
the lamp support being releasably and electrically conductively connected to a line-like power supply element by two congruent, current-conducting contact profiles,
wherein a first of the two contact profiles includes a permanent magnet and a second of the two contact profiles includes a permanent magnet and/or a ferromagnetic material,
wherein sides of the two contact profiles facing each other have different magnetic polarities and/or attract each other, the system further comprising
a rechargeable power supply having a further contact profile with a further permanent magnet or a further ferromagnetic material, which corresponds with the first of the two contact profiles in a magnetically retentive manner.

2. The power supply system according to claim 1, wherein the second of the two contact profiles and the further contact profile are formed identical.

3. The power supply system according to claim 1, wherein the rechargeable power supply comprises a housing, the housing having a wall in which the further contact profile is embedded.

4. The power supply system according to claim 3, wherein the housing has at least one opening, in which the further contact profile is embedded.

5. The power supply system according to claim 3, wherein the second of the two contact profiles is formed in an approximately flat plane with a surface of the wall.

6. The power supply system according to claim 3, wherein the two congruent, current-conducting contact profiles are formed such that the housing of the rechargeable power supply acts as a support of the lamp support.

7. The power supply system according claim 3, wherein the housing comprises releasable connecting means by which the housing can be arranged on objects.

8. The power supply system according to claim 1, wherein the two congruent, current-conducting contact profiles and the further contact profile are formed as plugs/sockets.

9. The power supply system according to claim 1, wherein the lamp support is formed conical.

10. A power supply system, comprising
a lamp support with a lamp, the lamp support having a first contact profile;
a wired power supply element having a second contact profile; and
a rechargeable power supply having a third contact profile,
wherein the first contact profile and the second contact profile are congruent and configured to attach to one another by magnetic force while establishing an electrical connection between the lamp support and the wired power supply element, and
wherein the first contact profile and the third contact profile are congruent and configured to attach to one another by magnetic force while establishing an electrical connection between the lamp support and the rechargeable power supply.
